(19) United States
(12) Patent Application Publication
(10) Pub. No.: US 2011/0302204 A1
(43) Pub. Date: Dec. 8, 2011

(54) METHOD AND APPARATUS FOR TEXT INFORMATION MANAGEMENT

(75) Inventor: Cheng Luo, Shenzhen City (CN)

(73) Assignee: TENCENT TECHNOLOGY (SHENZHEN) COMPANY LIMITED, Shenzhen (CN)

(21) Appl. No.: 13/208,469

(22) Filed: Aug. 12, 2011

Related U.S. Application Data
(63) Continuation of application No. PCT/CN2010/070360, filed on Jan. 26, 2010.

(30) Foreign Application Priority Data
Feb. 19, 2009 (CN) 200910037253.5

(51) Int. Cl. G06F 17/30

(52) U.S. Cl. 707/769; 707/E17.039

(57) ABSTRACT

A method and apparatus for text information management are provided. The method includes: generating a text expression corresponding to text information; searching for the text expression corresponding to the text information when the text information is to be used again, and obtaining the text information according to the text expression. Through the method and apparatus, a user can search for received text information simply, conveniently and rapidly without searching for text information from chatting records, and therefore lots of time can be saved.

### FIELD OF THE INVENTION

The present invention relates to the field of instant messaging technique, and more particularly, to a method and apparatus for text information management.

### BACKGROUND OF THE INVENTION

Since the functions of receiving and sending picture expressions are limited only to pictures and it mainly focus on visual exhibition, requirements for communications between users of the IM software cannot be satisfied. Based on this condition, users of the IM software tend to communicate with each other via text information. For example, in China, communications through the IM software in text information is abundant, amounting to hundreds of millions. Furthermore, some brilliant text passages (such as self-created poems, funny jokes and philosophical texts and so on) and collection-worthy text information may be transmitted frequently. However, existing IM software do not have special storage and management functions dedicated to the brilliant text passages and the collection-worthy text information. Therefore, when the user wants to use or send the received brilliant text passages and collection-worthy text information to the other party of communications, the user can only search for the received text passages and text information in all the chatting records one by one if the user can not remember the received text information, and then send the text information to the other party of communication when the text information is found.

As it is well known, there is a large amount of chat information in the chatting records. The process of searching for the text information to be sent in all of the chatting records one by one as described above would increase complexity of text information searching and occupy more time to send the text information.

### SUMMARY OF THE INVENTION

Embodiments of the present invention provide a method and apparatus for text information management, which can search for received text information simply, conveniently and rapidly.

The technical solution of the present invention is as follow:

According to an embodiment of the present invention, a method for text information management includes:
generating a text expression corresponding to text information; and
searching for the text expression corresponding to the text information when the text information is to be used again, and obtaining the text information according to the text expression.

According to another embodiment of the present invention, an apparatus for text information management includes:
a generating module, configured to generate a text expression corresponding to text information; and
an obtaining module, configured to search for the text expression corresponding to the text information when the text information is to be used again, and obtain the text information according to the text expression searched out.

As can be seen, the method and apparatus for text information management provided by embodiments of the present invention can generate the text expression corresponding to the text information needed by the user and search for the text expression corresponding to the text information when the text information would be used again, and can obtain the text information according to the text expression searched out by the user. As can be seen from the above, embodiments of the present invention can provide text information management. If the text information is needed, the text expression corresponding to the text information may be searched directly so as to find the corresponding text information. Therefore, the received text information can be searched simply, conveniently and rapidly, while the user does not need to search for the corresponding text information in chatting records, and therefore lots of time is saved.

### BRIEF DESCRIPTION OF THE DRAWINGS

FIG. 1 is a flowchart according to an embodiment of the present invention.

FIG. 2 is a flowchart according to an embodiment of the present invention.

FIG. 3 is a schematic diagram illustrating a structure of an apparatus according to an embodiment of the present invention.

FIG. 4 is a schematic diagram illustrating a structure of an apparatus according to an embodiment of the present invention.

### DETAILED DESCRIPTION OF THE INVENTION

In an embodiment of the present invention, text expressions are generated according to text information selected by a user. The user can search for the text expressions corresponding to the text information and obtain the text information according to the found text expressions when the text information would be used again. Thereby, it brings convenience to the user for sending brilliant or collection-worthy text information and can thus save time.

The present invention will be described in detail hereinafter with reference to embodiments and accompanying drawings to make an embodiment of the present invention clearer.

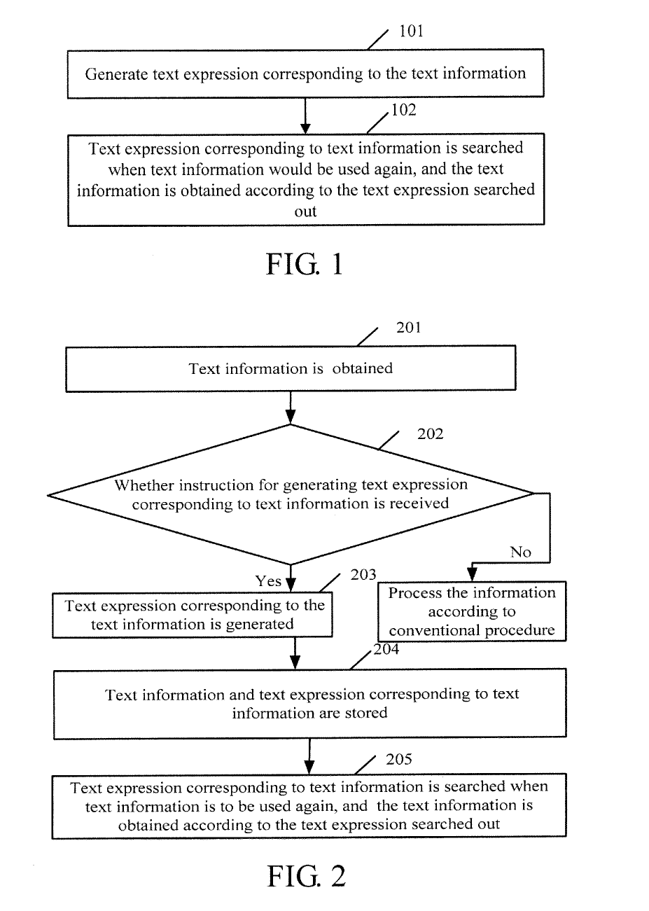

FIG. 1 is a flowchart of a method according to an embodiment of the present invention. As shown in FIG. 1, the method may include the follow steps:

Step 101, text expression corresponding to text information is generated.

The text information herein is the favorite part selected by the user from the text information that is received from the other party of communications or that is to be sent or that is found in chatting records of the user.

Step 102, the text expression corresponding to the text information is searched when the text information would be used again and the text information is obtained according to the text expression searched out.

Thus, the procedure in the embodiment of the present invention may be implemented.

As can be seen from the above, the method provided by the embodiment of the present invention has been described briefly and more detailed description will be provided hereinafter.

It should be point out that the operations of generating the text expression in step 101 and searching for the text information in step 102 may be performed by IM apparatus or a server corresponding to the IM apparatus. The following description takes the case that the operations are performed by the IM apparatus as an example.

FIG. 2 is a flowchart according to an embodiment of the present invention. As shown in FIG. 2, the method may include the follow steps after the user logs on the IM software:

Step 201, the text information is obtained.

The text information herein may be the favorite part selected by the user from the text information that is received from the other party of communications or that is to be sent or that is found in chatting records of the user.

According to an embodiment of the present invention, the text information obtained in step 201 may also be: the text information with unnecessary information such as nickname of buddies and time of each chatting record removed from the chatting records selected by the user. The chatting records selected by the user may be all the chatting records stored in the IM apparatus or part of the chatting records with a starting point determined by the user.

Step 202, it is determined whether an instruction for generating the text expression corresponding to the text information is received. If the instruction is received, proceed to step 203; otherwise, process the text information according to the conventional procedure.

The determination in step 202 may be as follow: provide selection menus or prompt buttons for the user so that the user can make a choice, determine whether the user chooses to generate the text expression corresponding to the text information; if yes, confirm that the instruction for generating the text expression corresponding to the text information is received; otherwise, confirm that no instruction for generating the text expression corresponding to the text information is received.

Step 203, the text expression corresponding to the text information is generated.

The step 203 may be realized in several ways. For example, characters with a predetermined length (for example, first several characters of the text information or the key characters which is able to express the main idea of the text information) is intercepted, or characters determined in advance are selected from the text information, or characters inputted by the user is selected from the text information. Thereafter, a sign is generated according to the selected characters, and the sign is determined as the text expression corresponding to the text information.

It needs to be pointed out that in the embodiment of the present invention, the text expression may be in a fixed format. Besides, the text expression may further include character information such as generating time and color of skins for differentiating different text expressions.

Step 204, the text information and the text expressions corresponding to the text information are stored.

In Step 204, a user may arrange text expressions first. For example, the user may sequence the text expressions first in a predetermined order before storing them. The predetermined order can be Chinese phonetic alphabet order, time order and so on. For another example, the user may sort the text expressions according to predetermined categories (the categories may be poems, jokes or satires and so on), i.e. classify the text expressions into different groups or categories. Based on this condition, the user can conveniently search for a text expression according to a predetermined order or category when the text expression would be used again. Thereafter, the arranged text expressions and the corresponding text information are stored on the IM apparatus.

According to an embodiment of the present invention, the user can store the text expressions and/or the corresponding text information respectively in the server. Thus, the user could obtain the stored text expressions and/or the corresponding text information more conveniently even if the user logs on the IM software in a different place.

Step 205, when the text information would be used again, the text expression corresponding to the text information is searched and the text information is obtained according to the text expression searched out.

A user can obtain the corresponding text information by clicking on the corresponding text expression when the user communicates with the other party of communications or wants to use the stored text information.

In the embodiment of the present invention, the searching in step 205 may include: obtain a search keyword inputted by the user, search for a text expression matching the search keyword from the stored text expressions. Since the generated text expression shows the character information for differentiating the text expression from the others, the search keyword may correspond to the character information. It can be seen in step 205 that the IM software provides a text expression searching function for the user. Thus, the user can find the text expression that he/she needs by inputting the search keyword, and then find the corresponding text information. In this way, this method can shorten searching time and bring convenience to the user.

Besides, according to the above description, the text expression and the corresponding text information may be stored in the server. Based on this condition, in step 205, if the text expression and the corresponding text information are stored in the server, the search keyword inputted by the user is sent to the server, and the server searches for the corresponding text expression and text information according to the search keyword. Thereafter, the text expression and the text information searched out by the server are obtained.

After step 205, an embodiment of the present invention may include the following. An edit instruction inputted by the user is received, the obtained text information is edited according to the edit instruction and is then stored in the server. It can be seen that in step 205, the IM software provides a text information edit function for the user, which enables the user to conveniently edit the obtained text information when the user needs to edit the text information (such as deleting, changing the font, color and size of the text information). The edited text information may be stored as new information or may directly cover the originally stored information according to practical requirements from the user.

It should be noted that the flowchart shown in FIG. 2 is illustrated in an example that operations of generating the text expression and searching for the text information are performed by the IM apparatus. In another embodiment of the present invention, the operations may be performed by the server corresponding to the IM apparatus instead. In this case, step 203 may be replaced by: the IM apparatus sends the text information to the server corresponding to the IM apparatus and the server generates the text expression corresponding to the text information. Step 204 may be replaced by: the server directly stores the text expression and the corresponding text information, or sends the text expression and the corresponding text information to the IM apparatus to be stored. Step 205 may be replaced by: if the text expression and the corresponding text information are stored in the server, the search keyword inputted by the user is sent to the server, and the server searches for the corresponding text expression and text information according to the search keyword, and then the text expression and text information which are searched out by the server may be obtained. Certainly, if the text expression and the corresponding text information have already been stored in the IM apparatus, step 205 can be performed as shown in FIG. 2. Other steps may be replaced in a similar way, which will not be described again.

The method provided by the embodiment of the present invention is described above, and an apparatus provided by an embodiment of the present invention will be described hereinafter.

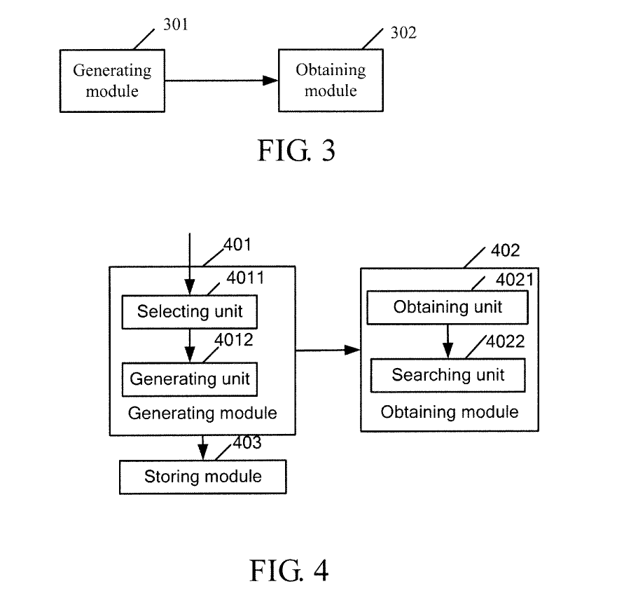

An embodiment of the present invention provides an apparatus for text information management. As shown in FIG. 3, the apparatus includes:
a generating module 301, configured to generate a text expression corresponding to text information; the text information may be chosen by the user from chatting records according to his/her preference; and
an obtaining module 302, configured to search for the text expression corresponding to the text information and obtain the text information according to the found text expression when the text information is to be used again.

The apparatus provided by the embodiment of the present invention is described briefly above, and it will be described in detail hereinafter.

FIG. 4 is a schematic diagram illustrating a structure of an apparatus according to an embodiment of the present invention. As shown in FIG. 4, the apparatus mainly includes: a generating module 401 and an obtaining module 402, and of which functions are respectively similar to the generating module 301 and the obtaining module 302 shown in FIG. 3.

In an embodiment of the present invention, as shown in FIG. 4, the generating module 401 may include:
a selecting unit 4011, configured to intercept characters with a predetermined length; or select preset characters from the text information; or select characters inputted by the user from the text information; and
a generating unit 4012, configured to generate a corresponding sign according to the characters and take the sign as the text expression corresponding to the text information.

In an embodiment of the present invention, as shown in FIG. 4, the obtaining module 402 may include:
an obtaining unit 4021, configured to obtain a search keyword inputted by the user; and
a searching unit 4022, configured to search for a text expression matching the search keyword.

In an embodiment of the present invention, as shown in FIG. 3, the apparatus may further include:
a storing module 403, configured to arrange text expressions, and store text information corresponding to the arranged text expressions in a local computer or upload and store the text information in the server; or,
to export the text information corresponding to the text expressions and store the exported text information in a format selected by the user; or,
to generate editable pictures corresponding to the text expressions in the form of pictures and store the pictures.

It should be noted that in the embodiment of the present invention, the apparatus shown in FIG. 4, may be set on the IM apparatus or the server corresponding to the IM apparatus.

In conclusion, a method and apparatus for text information management is provided by embodiments of the present invention, which can generate text expression corresponding to the text information needed by the user and search for the text expression corresponding to the text information when the text information would be used again, and can obtain the text information according to the text expression searched out by the user. As can be seen from the above, embodiments of the present invention can provide text information management. If the text information is needed, the text expression corresponding to the text information may be searched directly so as to find the corresponding text information. Therefore, the received text information can be searched simply, conveniently and rapidly, while the user does not need to search for the corresponding text information in chatting records, and therefore lots of time is saved.

The foregoing descriptions are only embodiments of this invention and are not for use in limiting the protection scope thereof. Any changes, equivalent replaces and ameliorations can be made by those skilled in the art without departing from the principle of this invention and therefore should be covered within the protection scope as set by the appended claims.

1. A method for text information management, comprising:
generating a text expression corresponding to text information; and
searching for the text expression corresponding to the text information when the text information is to be used again, and obtaining the text information according to the text expression.

2. The method of claim 1, wherein the generating comprises:
determining whether an instruction for generating the text expression corresponding to the text information is received;
if the instruction is received, generating the text expression corresponding to the text information.

3. The method of claim 1, wherein the generating the text expression corresponding to the text information comprises:
intercepting characters with a predetermined length, or selecting preset characters from the text information, or selecting characters inputted by a user from the text information; and
generating a sign corresponding to the characters and taking the sign as the text expression corresponding to the text information.

4. The method of claim 3, wherein the searching for the text expression corresponding to the text information comprises:
obtaining a search keyword inputted by the user and searching for the text expression matching the search keyword.

5. The method of claim 3, further comprising:
storing the text information corresponding to the text expression upon generating the text expression.

6. The method of claim 5, wherein the storing the text information corresponding to the text expression comprises:
arranging the text expression and storing the text information corresponding to the arranged text expression in a local computer or uploading the text information corresponding to the arranged text expression to a server to be stored; or
exporting the text information corresponding to the text expression and storing the exported text information in a format selected by the user; or,
generating an editable picture corresponding to the text information in a form of pictures and storing the editable picture.

7. The method of claim 1, wherein the text expression is generated by an Instant Messaging (IM) apparatus, or generated by a server corresponding to the IM apparatus.

8. An apparatus for text information management, comprising:
a generating module, configured to generate a text expression corresponding to text information; and
an obtaining module, configured to search for the text expression corresponding to the text information when the text information is to be used again, and obtain the text information according to the text expression searched out.

9. The apparatus of claim 8, wherein the generating module comprises:
a selecting unit, configured to intercept characters with a predetermined length; or select preset characters from the text information; or select characters inputted by a user from the text information; and
a generating unit, configured to generate a sign according to the characters and take the sign as the text expression corresponding to the text information.

10. The apparatus of claim 9, wherein the obtaining module comprises:
an obtaining unit, configured to obtain a search keyword inputted by the user;
a searching unit, configured to search for a text expression matching the search keyword.

11. The apparatus of claim 8, further comprising:
a storing module, configured to arrange the text expression and store the text information corresponding to the arranged text expression in a local computer, or upload and store the text information corresponding to the arranged text expression in a server; or
to export the text information corresponding to the text expression and store the exported text information in a format selected by a user; or,
to generate an editable picture corresponding to the text information in a form of pictures and store the editable picture.

12. The apparatus of claim 8, wherein the apparatus is located in an Instant Messaging (IM) apparatus or a server corresponding to the IM apparatus.
